(19) United States
(12) Patent Application Publication
(10) Pub. No.: US 2015/0021205 A1
(43) Pub. Date: Jan. 22, 2015

(54) Sampling method and system for measuring blood lactate concentrations

(71) Applicant: Nova Biomedical Corporation, Waltham, MA (US)

(72) Inventors: Jianhong Pei, Boxborough, MA (US); Chung Chang Young, Weston, MA (US)

(73) Assignee: Nova Biomedical Corporation, Waltham, MA (US)

(21) Appl. No.: 13/946,522

(22) Filed: Jul. 19, 2013

(51) Int. Cl. G01N 27/28

(52) U.S. Cl. CPC G01N 27/28
USPC 205/782; 204/403.02

(57) ABSTRACT

A method of measuring lactate in a blood sample taken from capillary blood using a skin lancing procedure includes disposing onto an area of skin on an animal a predefined amount of a skin treatment compound that is capable of suppressing and/or eliminating and/or preventing and/or blocking any sweat from the skin in the area of a lanced wound site, the compound being disposed on the skin either before lancing the area of skin that provides a droplet of capillary blood for measurement of blood lactate concentration or after lancing the area of skin but before a droplet of capillary blood forms on the skin in order to prevent contaminating the blood sample, and then measuring the lactate concentration of the blood sample with a disposable lactate sensor strip.

### BACKGROUND OF THE INVENTION

1. Field of the Invention

The present invention relates generally to electrochemical sensors that can be used for quantification of a specific component or analyte in a liquid sample. Particularly, the present invention relates to an electrochemical-based sensor for measuring lactate in biological fluids.

2. Description of the Prior Art

Lactate has a key role in intermediate metabolism and serves as a shuttle for oxidizable substrate between organs. In the liver, lactate is both a substrate for gluconeogenesis and a product of glycolysis. In many tissues, lactate is generated and metabolized simultaneously. Normally, the overall rate of lactate concentration in the whole body does not change much because formation and metabolism can occur simultaneously inside the same cell.

Cells require energy in order to perform their normal functions and maintain homeostasis. This energy comes from the energy contained within ATP, adenosine triphosphate, which is predominantly derived from glucose. The most efficient, albeit slower, method of generating ATP is under aerobic conditions, where oxygen is present and consumed. This method is named as an oxidation, or oxidative pathway. The initial steps in the breakdown of glucose involve conversion of a one six-carbon molecule of glucose to two three-carbon molecules of pyruvate. This process is known as glycolysis. In the presence of oxygen, the carbon atoms in pyruvate are converted into three molecules of carbon dioxide in a process known as aerobic metabolism. The creation of ATP by aerobic means is typically favored by physical performance efforts of longer duration. The complete oxidation of one molecule of glucose yields up to 36 ATP molecules.

In the absence of oxygen, ATP is generated by way of another faster, but less efficient, pathway called anaerobic glycolysis. Without oxygen, all the electron acceptors “downstream” from pyruvate are reduced and unable to offload electrons to mediators that will carry them towards oxygen. Pyruvate itself then becomes reduced to lactate and broken down no further. The metabolic process that begins with glucose and ends with lactate is known as anaerobic metabolism. Being less efficient than oxidation (i.e. aerobic metabolism), one molecule of glucose in anaerobic metabolism yields only two ATP molecules. This is far less than 36 molecules of ATP obtained through oxidation. Anaerobic metabolism creates two lactic acid molecules for each glucose molecule. Increased use of anaerobic glycolysis results in higher rates of glucose utilization, glycogen depletion, and lactic acid production. The state of lactic acid is such that it dissociates almost totally into ionized form resulting in lactate and proton. Lactate itself may be metabolized by oxidation or converted to glucose or amino acids in liver.

The lactate concentration is of particular importance in the supervision of the training of athletes, such as triathletes and marathon runners. It is not only important in the supervision of training of professional athletes, but knowing one's lactate concentration is also important for people indulging in sports as a hobby.

In endurance sports, much of the training is to take place in the so-called aerobic range, i.e. a range where the oxygen taken in by respiration is sufficient to provide the required energy. The generation of every lactate is matched by its removal/metabolism. In this situation, lactate does not tend to accumulate. If this is not the case, the training takes place in the so-call anaerobic range where the amount of oxygen taken in is no longer sufficient to provide the required energy. The intensity of effort at which this occurs for any given individual is designated as that individual's blood lactate threshold. Beyond this limit, lactate begins to accumulate in the cellular environment followed by a measureable accumulation in the blood. The lactate threshold defines the onset of significant anaerobic glycolysis. Thus, the determination of lactate is important for the control of a proper training regimen.

Blood lactate levels can be used to determine the optimal workload for an athlete's training. Below the optimal workload, glucose metabolism is aerobic. In other words, the oxygen taken in by respiration is sufficient to provide the required energy for the training. At some point when the workload increases, the body's ability to supply increasing oxygen to working muscles becomes limited. At this moment, the lactate level no long maintains balance, but instead builds up quickly if the exercise continues to increase beyond this threshold. So, the determination of blood lactate can be useful in optimizing training work for athletes.

Measurement of blood lactate is also widely recognized as an important method of monitoring patients for tissue hypoxia. Clinically, elevation of resting blood lactate concentration is associated with increased severity of illness and mortality risk. Circulatory shock is the most prevalent result of severe lactate elevations. On the other hand, lactate elevations have been also attributed to a number of common disease states such as liver disease, cancer, pulmonary embolism, pancreatitis, sepsis, and others. Thus, lactate measurement has its greatest application in clinical settings that involve critically ill patients.

Correctly measuring blood lactate concentration, however, is a challenged work. After a blood specimen is obtained, the erythrocytes will continue to produce lactate in vitro. This will lead to spuriously low glucose concentration and a spuriously elevated lactate concentration if the blood specimen is allowed to stand for a prolonged period of time prior to performing the analysis. Measuring the blood lactate concentration shortly or simultaneously after drawing a blood sample is very important. Commercially-available, handheld, portable monitors have been developed for blood lactate concentration measurements. These handheld monitors include the Accusport/Accutrend (Roche Diagnostics), the Lactate Pro (Arkray, Japan) and the Nova StatStrip Lactate (Nova Biomedical Corporation). The portable lactate monitors resemble the blood glucose monitors of late 1980s in their ease of use. Portable lactate monitors allow measurement of blood lactate using a very small volume of capillary blood collected from the finger or ear by lancet puncture. The blood lactate measurement has become widely performed for scientific management of training.

### SUMMARY OF THE INVENTION

Although portable lactate monitors have been available, the accurate measurement of blood lactate suffers from certain drawbacks. Sweat contains a very high lactate content in the range of about 15 mM to about 60 mM. In comparison, normal lactate levels in the blood are about 0.5 mM to about 2.2 mM. The lactate in sweat results from eccrine gland metabolism. Sweat glands are small tubular structures of the skin that produce sweat. There are two main types of sweat glands: Eccrine sweat glands and apocrine sweat glands. Eccrine sweat glands are distributed almost all over the body, though their density varies from region to region. Humans utilize eccrine sweat glands as a primary form of cooling. Apocrine sweat glands are larger, have a different secretion mechanism, and are mostly limited to the axilla (armpits) and perianal areas in humans. Unlike eccrine glands, apocrine glands contribute little to cooling in humans.

The possible clearance of blood lactate through sweat has not been resolved. So care must be taken to avoid contamination of blood sample by sweat because of the high concentration of sweat lactate. It is important to dry and clean the area thoroughly before obtaining a blood sample. In fact no matter how carefully the area of sampling is cleaned and dried, obtaining a blood sample free of contamination is very difficult. Blood lactate measurements are always affected by the sweat lactate concentration where the “finger prick or lancing” method of obtaining the blood sample is used.

If finger blood lactate measurements are to be used to monitor physical training or to diagnosis for illness, valid and reliable measurements must be obtained. In the absence of valid and reliable blood lactate data, any positive training response that occurs on the basis of these data occurs by chance or by coincidence and not based on the actual blood lactate levels. The most common field sampling site for lactate is at the finger tip, which yields capillary blood, but the ear is also an alternative lancing site. Because of the small volume of blood sample obtained for measuring lactate concentration, lactate contamination from the sweat can be problematic. This is so because lactate levels in sweat are considerably higher than the lactate levels in blood. This difference can range from about 7 to about 1200 times higher in sweat than in blood. If even a small quantity of sweat is accidentally mixed with the blood sample, an erroneously high reading for blood lactate is obtained.

It is an object of the present invention to provide a method of obtaining an accurate blood lactate measurement when using a skin-lancing sampling method.

The present invention achieves these and other objectives by providing a predefined amount of a skin treatment compound that is capable of suppressing and/or eliminating and/or preventing and/or blocking any sweat from the skin in the area of a lanced wound site. The skin treatment compound also optionally has the characteristic of providing accurate lactate measurements up to 3 minutes after formation of the blood sample on the skin and before being disposed in a disposable lactate sensor strip. The skin treatment compound is disposed on the skin either before lancing the area of skin that provides a droplet of capillary blood for measurement of blood lactate concentration or after lancing the area of skin but before a droplet of capillary blood forms on the skin in order to prevent contaminating the blood sample.

In one embodiment of the present invention, there is disclosed a method of measuring lactate in a blood sample taken from capillary blood using a skin lancing procedure. The method includes disposing onto an area of skin on an animal a predefined amount of a skin treatment compound in the area of skin to be lanced. A predefined amount of the blood sample is obtained after disposing the compound on the skin area. A portion of the blood sample is disposed into a lactate sensor strip, which is then measured for lactate concentration using a handheld meter.

In another embodiment of the present invention, the skin treatment compound is selected from antiperspirants, deodorants and petroleum jelly.

In a further embodiment of the present invention, the skin treatment compound is selected from hydrogenated soybean oil, dicaprylyl ether, aluminum chlorohydrate, palm kernel oil, stearyl alcohol, hydrogenated castor oil, and petroleum jelly.

In still another embodiment of the present invention, the skin treatment compound has a concentration in a range of about 1% to 100%, of about 10% to 50% and of about 15% to 30%

In yet another embodiment of the present invention, the method includes wiping the area of skin with a cleaning wipe before disposing the skin treatment compound onto the area of skin and followed by lancing the area of skin to obtain the blood sample.

In another embodiment of the present invention, the method includes wiping the area of skin with a cleaning wipe, lancing the area of skin cleaned with the cleaning wipe creating a wound, obtaining a predefined amount of blood sample, and removing the predefined amount of blood sample from the wound using a cleaning wipe before disposing the predefined amount of the skin treatment compound onto the wound before a second droplet of capillary blood forms on the skin.

In one embodiment of the present invention, a kit for measuring lactate in a blood sample is disclosed. The kit includes the skin treatment compound and instructions on disposing the skin treatment compound according to a predefined blood sample obtaining method. The instructions include instructing a user to dispose the skin treatment compound on the skin either before lancing the area of the skin that provides the blood sample for measuring lactate concentration or after lancing the area of skin for the blood sample but before a droplet of capillary blood forms on the skin. This technique and skin treatment compound prevents contamination of the blood sample with sweat from the skin.

In still another embodiment of the present invention, a disposable lactate sensor system for measuring lactate in a blood sample is disclosed. The system includes a disposable lactate sensor configured for receiving a blood sample of capillary blood from a lanced skin area and capable of coupling with the handheld meter to measure lactate concentration in the blood sample, and a quantity of a skin treatment compound in a form for disposing onto the skin in the area to be lanced either before lancing or after lancing but before formation of the blood sample from the lanced area. The skin treatment compound may be applied in the form of a spray, a liquid, a gel, and the like using application devices such as wipes, spray containers, dipping, coating, etc.

In another embodiment of the present invention, the system includes instructions instructing a user to wipe the area of skin from which a blood sample is to be obtained with a cleaning wipe before disposing the skin treatment compound onto the area before obtaining the blood sample. The cleaning wipe may be an alcohol wipe.

In further embodiment of the present invention, the instructions in the system includes instructing a user to (1) wipe the area of skin from which a blood sample is to be obtained with a cleaning wipe, (2) lance the area of skin, (3) obtain a blood sample, and (4) remove the blood sample using a cleaning wipe before disposing the skin treatment compound onto the wound site. The skin treatment compound is instructed to be disposed before obtaining a second blood sample that is used to measure the lactate concentration in the blood sample.

It is a further embodiment of the present invention to use a skin treatment compound that allows for up to 3 minutes delay from blood formation in the skin to acquisition by the lactate sensor.

### BRIEF DESCRIPTION OF THE DRAWINGS

FIGS. 1A, 1B and 1C illustrate one embodiment of the method of the present invention for obtaining a blood sample to measure lactate concentration in the blood.

FIGS. 2A, 2B, 2C, and 2D illustrate another embodiment of the method of the present invention for obtaining a blood sample to measure lactate concentration in the blood.

FIGS. 3A, 3B, 3C, 3D, 3E, and 3F illustrate still another embodiment of the method of the present invention for obtaining a blood sample to measure lactate concentration in the blood.

FIGS. 4-8 are graphic illustrations of the test data of Table 1 showing each test subjects blood lactate concentration using the standard method of skin cleaning and Method #2 of the present invention.

FIG. 9 is a graphic illustration of blood lactate concentration test data showing the standard method of skin cleaning and the three methods described by the present invention for obtaining a capillary blood droplet.

### DETAILED DESCRIPTION OF THE PREFERRED EMBODIMENT

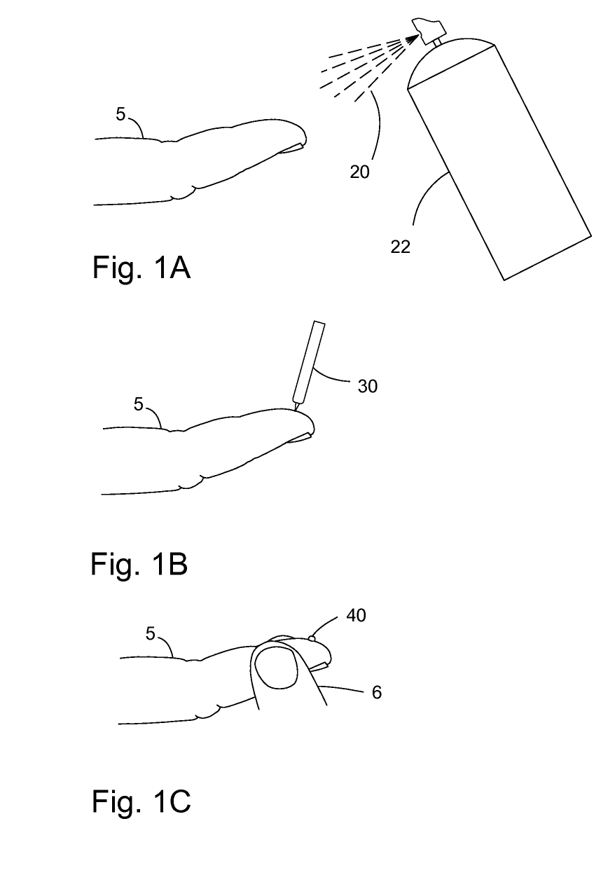

The preferred embodiments of the present invention are illustrated in FIGS. 1-9. FIGS. 1A to 1C shows one embodiment of the method of the present invention for obtaining a blood sample to measure lactate concentration in the blood. In the first step of a preferred method, a finger 5 from which a blood sample is to be obtained is treated with a predefined compound/material 20. The predefined compound/material 20 is a skin treatment compound capable of suppressing and/or eliminating and/or preventing and/or blocking any sweat from the skin from contaminating the blood sample. Finger 5 is then lanced with a lancet 30 much like one that is used for obtaining blood to measure glucose by a person with diabetes. Next, a blood droplet 40 is squeezed from the wound site created by the lancing step. Typically, a user would use the forefinger and thumb 6 of the other hand to squeeze finger 5 to more quickly generate the blood sample. Once obtained, blood droplet 40 is disposed into a disposable test strip (not shown) for measuring lactate. Capillary action is force typically relied upon to move the blood droplet 40 from the squeezed finger 5 to the test chamber of the disposable test strip. In typical fashion, the lactate test strip is preferably already connected to the meter/monitor just prior to obtaining the blood sample. This procedure takes advantage of the meter/monitor's ability to determine whether a sufficient amount of blood sample has entered into the test chamber of the disposable test strip. It is understood that other areas of the body other than a finger may be used to obtain the blood droplet sample. This is particularly so for animals that do not have fingers per se. These other areas need only be areas where capillary blood can be easily obtained by lancing the skin of the animal.

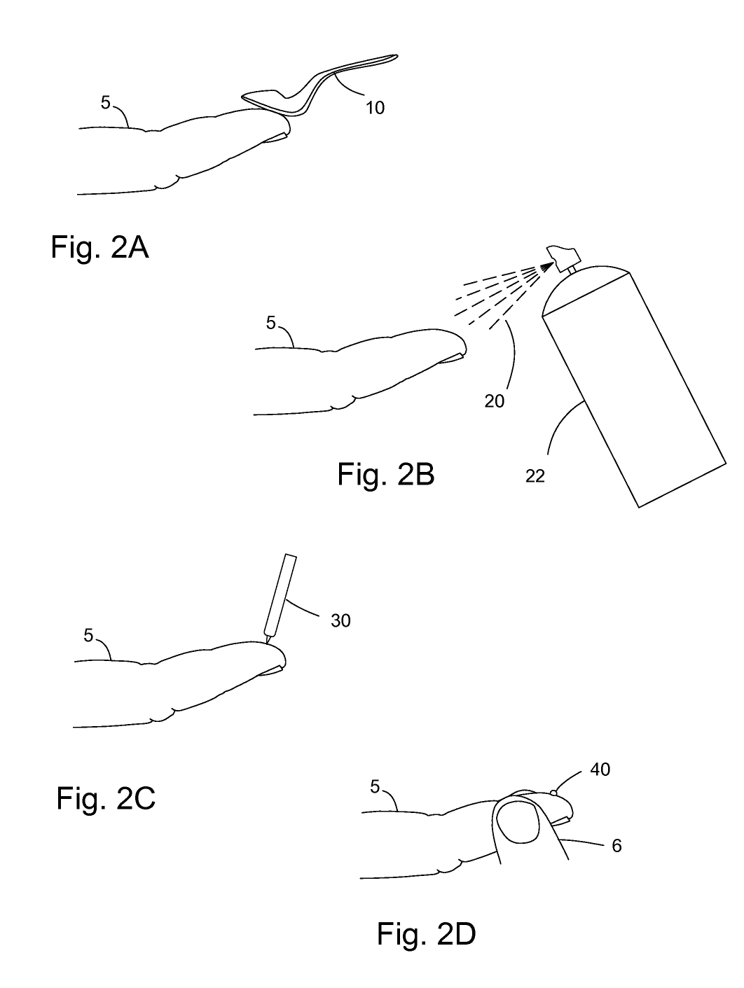

Turning now to FIGS. 2A to 2D, there is illustrated another method of the present invention for obtaining a blood sample to more accurately measure lactate concentration in the blood. In this embodiment, a finger 5 is wiped with an alcohol wipe 10 to pre-clean the skin area where the blood droplet is to be obtained for the test measurement. After wiping finger 5 with alcohol wipe 10, finger 5 is then treated with a predefined compound/material 20. Finger 5 is then lanced with a lancet 30 in the same way as previously described in FIGS. 1A to 1C. Next, a blood droplet 40 is squeezed from the wound site created by the lancing step. The wound area on finger 5 is squeezed to obtain a blood droplet for testing. As described above, once obtained, blood droplet 40 is disposed into a disposable test strip (not shown) for measuring lactate concentration.

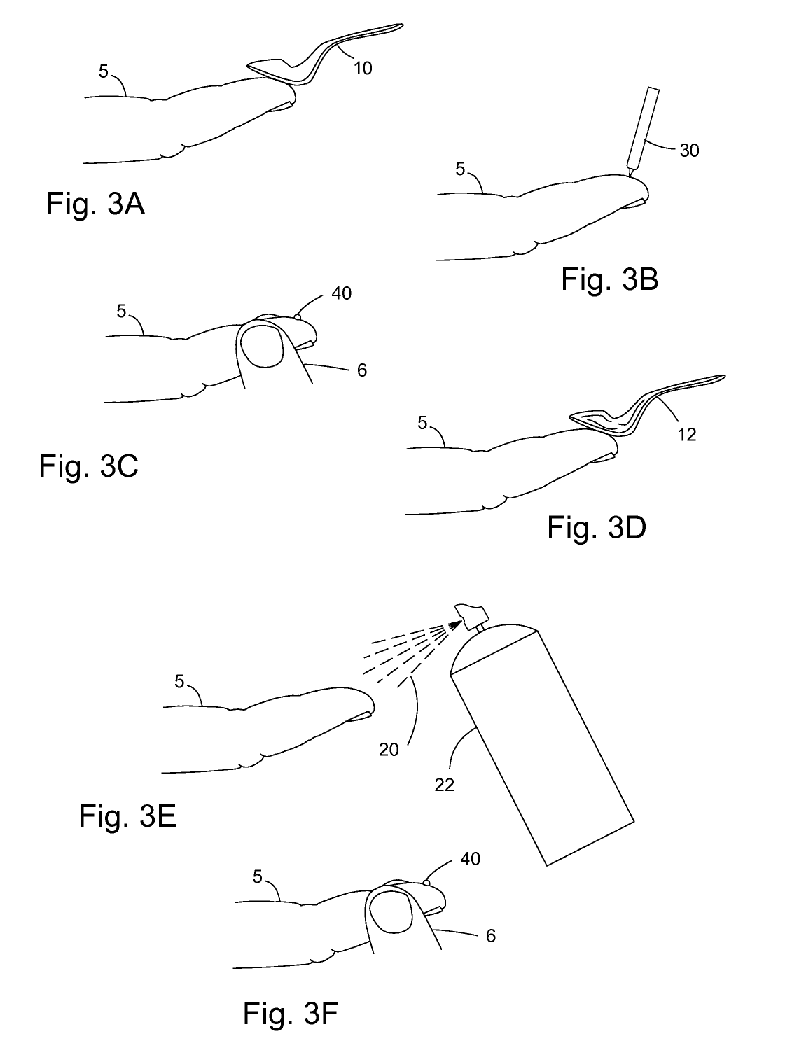

FIGS. 3A to 3F illustrate still another embodiment of the present invention. In this embodiment, a finger 5 is wiped with an alcohol wipe 10 to pre-clean the skin area where the blood droplet is to be obtained for the test measurement. After wiping finger 5 with alcohol wipe 10, finger 5 is then lanced with a lancet 30 in the same way as previously described in FIGS. 1A to 1C and FIGS. 2A to 2D. Next, a blood droplet 40a is squeezed from the wound site created by the lancing step. In this method, blood droplet 40a is wiped from finger 5 using a sanitary wipe such as an alcohol wipe, gauze and the like. Following the wipe of blood droplet 40a from the wound site, finger 5 is then treated with a predefined compound/material 20. Finger 5 is then squeezed at or next to the wound site to obtain a second blood droplet 40b for testing. As described above, once obtained, blood droplet 40b like the prior blood droplets 40 in the previously described methods is disposed into a disposable test strip (not shown) for measuring lactate.

The predefined compound/material 20 is selected from various compounds capable of suppressing and/or eliminating and/or blocking any sweat from the skin in the area of the wound site. The critical step of any method used to obtain a blood droplet sample for measuring the concentration of lactate is the treatment of the skin with the predefined compound/material 20 before (preferably immediately before) obtaining the blood droplet 40 for the lactate test. The purpose of this critical step is to prevent contamination of the blood sample in the area of the skin where the blood sample is obtained. As previously explained, sweat contains many times higher concentration of lactate than is typically found in the blood. Thus, a small amount of contamination may adversely affect the measured amount of lactate. The ingredients for such a predefined compound/material 20 includes, but is not limited to, antiperspirants, deodorants and petroleum jelly or any other compound that has the critical characteristic and/or property capable of suppressing and/or eliminating and/or preventing and/or blocking any sweat from the skin in the area of the wound site from contaminating the blood droplet sample. Other examples of acceptable skin treatment compounds for compound/material 20 include hydrogenated soybean oil, dicaprylyl ether, aluminum chlorohydrate, palm kernel oil, stearyl alcohol, hydrogenated castor oil, and petroleum jelly.

The following examples demonstrate the advantage of the present invention to the accurate measurement of lactate concentration in a blood droplet sample. The test data was obtained using a Nova StatStrip Lactate monitor for obtaining the lactate concentration in the blood sample. The other similar meters/monitors (i.e. the Lactate Pro and the Accusport) produced similar results as the Nova Statstrip Lactate monitor.

### EXAMPLE #1

In this first example, a comparison between the typical standard and normal method for cleaning the skin area prior to obtaining a blood droplet such as alcohol wipes (i.e. without using the critical step of the present invention, which is to treat the skin with a compound capable of suppressing and/or eliminating and/or preventing and/or blocking sweat from contaminating the blood sample) and the second embodiment described above and illustrated in FIGS. 2A to 2D is performed (the “Method #2). Table 1 below contains the lactate concentration test results for the “usual method” of cleaning the skin area prior to obtaining the blood sample and the method of the present invention described and illustrated in FIGS. 2A to 2D. The test subjects numbered five people and the sample for each test was taken from four different fingers of a test subject. The reference values were obtained using a Dimension RxL Chemistry System instrument. All lactate values are measured in millimolar (mM) concentration.

TABLE 1

| | Std. Method | | | | Method #2 | | | | |
|---|---|---|---|---|---|---|---|---|---|
| Test | Finger | Finger | Finger | Finger | Finger | Finger | Finger | Finger | Reference |
| Subject | #1 | #2 | #3 | #4 | #1 | #2 | #3 | #4 | value (mM) |
| #1 | 1.9 | 1.4 | 1.7 | 1.6 | 1.3 | 1.3 | 1.4 | 1.3 | 1.3 |
| #2 | 1.6 | 2.1 | 2.3 | 1.9 | 1.7 | 1.6 | 1.6 | 1.7 | 1.7 |
| #3 | 1.1 | 1.5 | 1.3 | 1.4 | 1.3 | 1.3 | 1.2 | 1.2 | 1.2 |
| #4 | 3.9 | 3.1 | 3.3 | 4.4 | 3.4 | 3.4 | 3.6 | 3.5 | 3.5 |
| #5 | 5.1 | 5.6 | 4.4 | 4.8 | 4.2 | 4.2 | 4.4 | 4.3 | 4.5 |

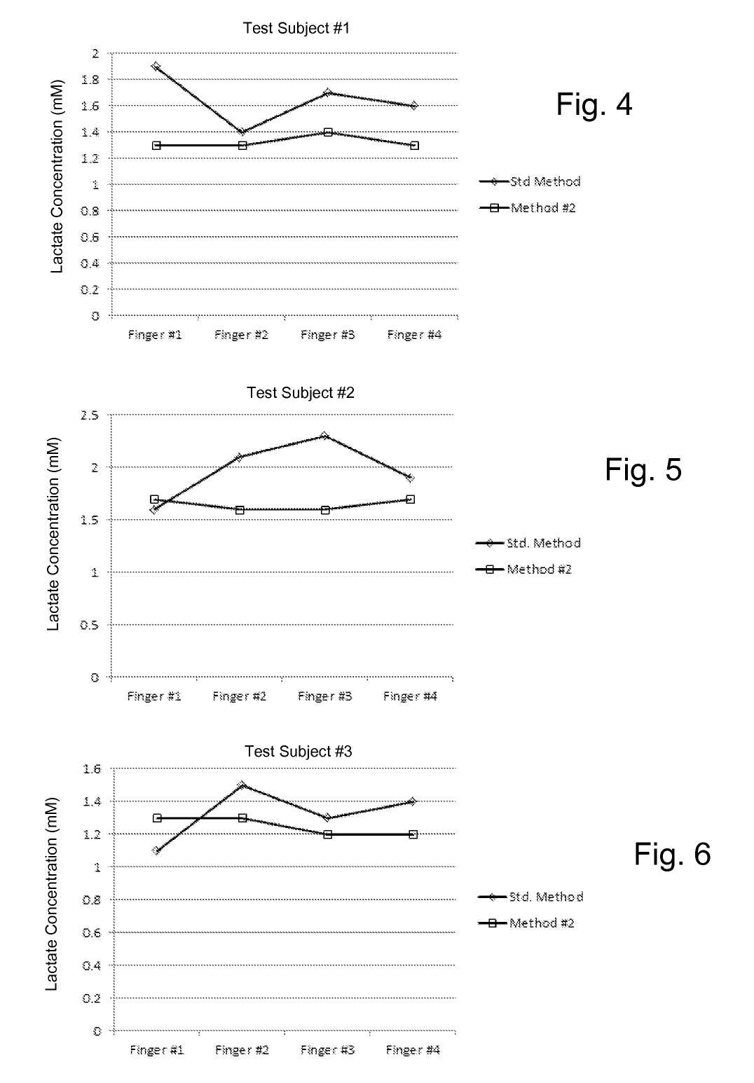

From Table 1, it can be seen that the usual method of cleaning the skin area gives very poor precision for the lactate measurement of the blood samples from the four fingers of a test subject. For example, test subject #1 has a lactate concentration range of 0.6 mM from the lowest to the highest value, test subject #2 has a range of 0.8 mM, test subject #3 has a range of 0.5 mM, test subject #4 has a range of 1.4 mM, and test subject #5 has a range of 1.3 mM.

Where the skin treatment of Method #2 was used, a very good precision for the lactate measurement of the blood samples from the four fingers of a test subject was obtained. Test subjects #1, #2 and #3 had a lactate concentration range of 0.2 mM from the lowest to the highest value. Test subjects #4 and #5 had a lactate concentration range of 0.3 mM. A graphic illustration of the test data of each test subject is shown in FIGS. 4-8.

As can be seen from the test data in Table 1 and FIGS. 4-8, the use of the skin treatment compound of the present invention provides more accurate lactate readings consistent with the reference values. The presumption is that the very poor precision was obtained due to the contamination from sweat. On the other hand, the Method #2 procedure produced very valid and reliable measurements. This result was completely unexpected.

### EXAMPLE #2

In this example, the lactate measurement tests included varying the length of time the blood sample remains on the skin prior to disposing the sample in the test strip by way of capillary action. This example involves a comparison between the typical standard and normal method for cleaning the skin area with a wipe such as an alcohol wipe prior to obtaining a blood droplet using the finger prick/lancing method (i.e. without using the critical step of the present invention, which is to treat the skin with a compound capable of suppressing and/or eliminating and/or preventing and/or blocking sweat from contaminating the blood sample) and the three disclosed embodiments of the present invention described above and illustrated in FIGS. 1A to 1C (the “Method #1”), FIGS. 2A to 2D (the “Method #2”) and FIGS. 3A to 3F (the “Method #3”) are performed. The standard method of obtaining blood for a lactate measurement using the finger prick/lancing method and the various tests were conducted to determine the effect time on the precision of the lactate reading. One finger was lanced using the standard method of cleaning the skin without using the skin treatment compound of the present invention and three other fingers were pricked/lanced using the methods mentioned above (Methods #1, #2 and #3) with the skin treatment compound. The lactate concentration measurements were made at 0 second, 30 second, one minute, one and half minute, two minute, two and half minute and three minute intervals after formation of the blood droplet on the finger. In other words, the blood droplet was allowed to stand on the finger a predefined period of time before disposing the blood into a lactate test strip for measurement. The results of the lactate test data are shown in Table 2.

TABLE 2

| Sampling | | | | | | | |
|---|---|---|---|---|---|---|---|
| methods | 0 s | 30 s | 1 m | 1.5 m | 2 m | 2.5 m | 3 m |
| Std. Method | 1.6 | 2.0 | 2.4 | 3.1 | 3.5 | 3.6 | 4.3 |
| Method #1 | 1.5 | 1.6 | 1.5 | 1.4 | 1.7 | 1.6 | 1.7 |
| Method #2 | 1.6 | 1.5 | 1.6 | 1.6 | 1.5 | 1.6 | 1.8 |
| Method #3 | 1.6 | 1.6 | 1.5 | 1.7 | 1.5 | 1.7 | 1.6 |

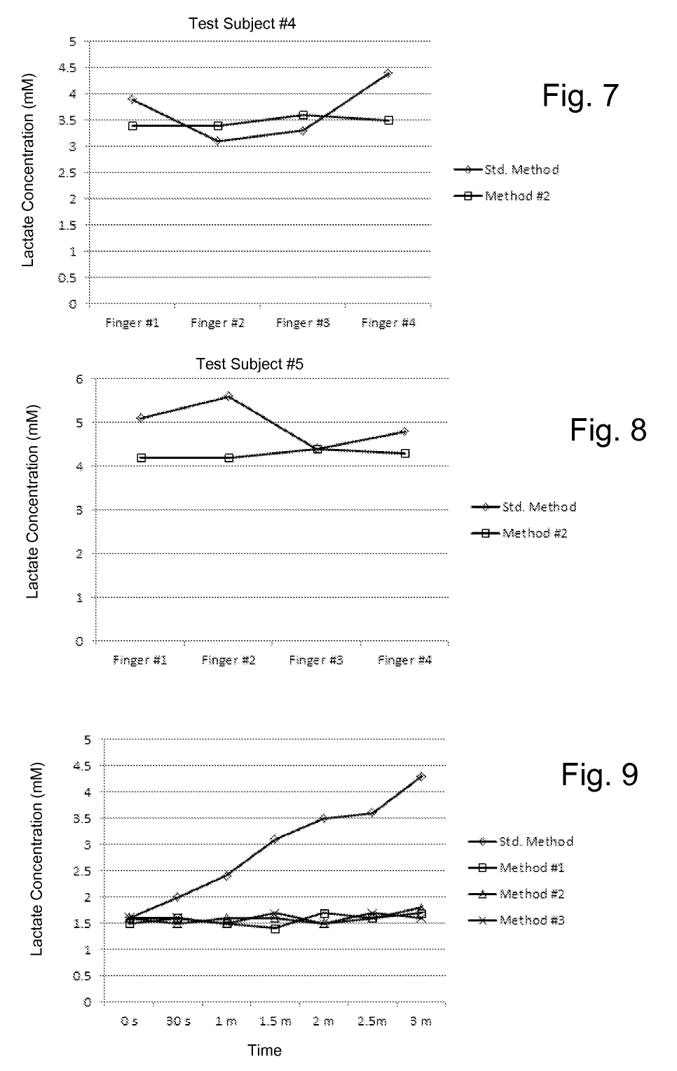

A graphic illustration of the test data is shown in FIG. 9. As illustrated in Table 2 and FIG. 9, the blood sample tested where the standard method was used for cleaning the finger prick area before lancing the finger shows an increase in lactate concentration with increasing time. This indicates that the lactate in the sweat contaminated the blood sample and resulted in higher, inaccurate lactate readings. The blood samples tested using Methods #1, #2 or #3 where the skin was treated with the treatment compound of the present invention shows that the use of treatment compound on the skin area before lancing the finger effectively eliminates lactate contamination caused by sweat.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A method of measuring lactate in a blood sample taken from capillary blood using a skin lancing procedure, the method comprising:
disposing onto an area of skin on an animal a predefined amount of a skin treatment compound that is capable of suppressing and/or eliminating and/or preventing and/or blocking any sweat from the skin in the area of a lanced wound site, the skin treatment compound being disposed on the skin either before lancing the area of skin that provides a droplet of capillary blood for measurement of blood lactate concentration or after lancing the area of skin but before a droplet of capillary blood forms on the skin in order to prevent contaminating the blood sample;
obtaining a predefined amount of the blood sample after disposing the compound onto the area of skin;
disposing a portion of the obtained blood sample into a lactate test strip; and
measuring the lactate concentration of the blood sample;
wherein the skin treatment compound is one of an antiperspirant or a deodorant.

2. (canceled)

3. The method of claim 1 further comprising selecting the skin treatment compound from the group consisting of hydrogenated soybean oil, dicaprylyl ether, aluminum chlorohydrate, palm kernel oil, stearyl alcohol, and hydrogenated castor oil.

4. The method of claim 3 wherein the skin treatment compound selecting step further includes selecting a skin treatment compound with a concentration selected from the group consisting of 1% to 100%, 10% to 50% and 15% to 30%.

5. The method of claim 1 further comprising selecting a skin treatment compound capable for up to three minutes of minimizing sweat contamination of a blood sample on the skin following lancing of the skin.

6. The method of claim 1 further comprising wiping the area of skin with a cleaning wipe before disposing the skin treatment compound onto the area of skin and followed by lancing the area of skin to obtain the blood sample.

7. The method of claim 1 further comprising:
wiping the area of skin with a cleaning wipe;
lancing the area of skin cleaned with the cleaning wipe creating a wound;
obtaining a predefined amount of blood sample from the wound; and
removing the predefined amount of blood sample from the wound using a cleaning wipe before disposing the predefined amount of the skin treatment compound onto the wound and before a second droplet of capillary blood forms on the skin.

8. A kit for obtaining a sample of capillary blood from the skin of an animal to measure blood lactate concentration, the kit comprising:
a skin treatment compound that is capable of suppressing and/or eliminating, and/or preventing, and/or blocking any sweat from an area of the skin to be lanced where a blood sample is obtained for measuring lactate in the blood sample from contaminating the blood sample; and
instructions on disposing the skin treatment compound according to a predefined blood sample obtaining method wherein the skin treatment compound is disposed on the skin either before lancing the area of the skin that provides the blood sample for measuring lactate concentration or after lancing the area of skin for the blood sample but before a droplet of capillary blood forms on the skin in order to prevent contamination of the blood sample with sweat from the skin
wherein the skin treatment compound is one of an antiperspirant or a deodorant.

9. (canceled)

10. The kit of claim 8 wherein the skin treatment compound is selected from the group consisting of hydrogenated soybean oil, dicaprylyl ether, aluminum chlorohydrate, palm kernel oil, stearyl alcohol, and hydrogenated castor oil.

11. The kit of claim 8 wherein the skin treatment compound has a concentration selected from the group consisting of 1% to 100%, 10% to 50% and 15% to 30%.

12. The kit of claim 8 wherein the instructions include instructing a user to wipe the area of skin from which a blood sample is to be obtained with a cleaning wipe before disposing the skin treatment compound onto the area before obtaining the blood sample.

13. The kit of claim 8 wherein the instructions include instructing a user to (1) wipe the area of skin from which a blood sample is to be obtained with a cleaning wipe, (2) lance the area of skin, (3) obtain a blood sample, and (4) remove the blood sample using a cleaning wipe before disposing the skin treatment compound onto the wound site, which skin treatment compound is instructed to be disposed before obtaining a second blood sample that is used to measure the lactate concentration in the blood sample.

14. A disposable, lactate sensor system for use with a handheld meter to optimize athletic training or to monitor patients for tissue hypoxia, the system comprising:
a disposable lactate sensor configured for receiving a blood sample of capillary blood from a lanced skin area and capable of coupling with the handheld meter to measure lactate concentration in the blood sample; and
a quantity of a skin treatment compound capable of suppressing and/or eliminating, and/or preventing, and/or blocking any sweat from an area of the skin to be lanced where a blood sample is obtained for measuring lactate in the blood sample from contaminating the blood sample, the quantity of the skin treatment compound being in a form for disposing onto the skin in the area to be lanced either before lancing or after lancing but before formation of the blood sample from the lanced area
wherein the skin treatment compound is one of an antiperspirant or a deodorant.

15. (canceled)

16. The system of claim 14 wherein the skin treatment compound is selected from the group consisting of hydrogenated soybean oil, dicaprylyl ether, aluminum chlorohydrate, palm kernel oil, stearyl alcohol, and hydrogenated castor oil.

17. The system of claim 14 wherein the skin treatment compound has a concentration selected from the group consisting of 1% to 100%, 10% to 50% and 15% to 30%.

18. The system of claim 14 further comprising instructions on disposing the skin treatment compound according to a predefined blood sample obtaining method wherein the skin treatment compound is disposed on the skin either before lancing the area of the skin that provides the blood sample for measuring lactate concentration or after lancing the area of skin for the blood sample but before a droplet of capillary blood forms on the skin in order to prevent contamination of the blood sample with sweat from the skin.

19. The system of claim 18 wherein the instructions instructing a user to wipe the area of skin from which a blood sample is to be obtained with a cleaning wipe before disposing the skin treatment compound onto the area before obtaining the blood sample.

20. The system of claim 18 wherein the instructions include instructing a user to (1) wipe the area of skin from which a blood sample is to be obtained with a cleaning wipe, (2) lance the area of skin, (3) obtain a blood sample, and (4) remove the blood sample using a cleaning wipe before disposing the skin treatment compound onto the wound site, which skin treatment compound is instructed to be disposed before obtaining a second blood sample that is used to measure the lactate concentration in the blood sample.
